(19) United States
(12) Patent Application Publication
(10) Pub. No.: US 2017/0228773 A1
(43) Pub. Date: Aug. 10, 2017

(54) INFORMATION PROVISION DEVICE, INFORMATION PROVISION METHOD, AND INFORMATION PROVISION SYSTEM

(71) Applicant: PANASONIC INTELLECTUAL PROPERTY MANAGEMENT CO. LTD., Osaka (JP)

(72) Inventor: Hisashi TAKAYAMA, Tokyo (JP)

(21) Appl. No.: 15/501,391

(22) PCT Filed: Jul. 30, 2015
(86) PCT No.: PCT/JP2015/003835

§ 371 Date: Feb. 2, 2017

(30) Foreign Application Priority Data
Aug. 4, 2014 (JP) 2014-158782

(51) Int. Cl. G06Q 30/02; G06Q 30/06

(52) U.S. Cl. CPC G06Q 30/0254; G06Q 30/0635

(57) ABSTRACT

An information provision device includes an obtainer, a collector, an extractor, and a presentation controller. The obtainer obtains profit information about a profit gained by a user by performing a measure of reducing a quantity of resource purchased from a provider. The collector collects product information including information about a price of a product and advertisement information of the product. The extractor extracts advertisement information of a product whose product information satisfies a predetermined relationship with the profit information from among the product information collected by the collector, as specific information. The presentation controller causes a presentation device to present the specific information extracted by the extractor.

### RELATED APPLICATIONS

This application is the U.S. National Phase under 35 U.S.C. §371 of International Patent Application No. PCT/JP2015/003835, filed on Jul. 30, 2015, which in turn claims the benefit of Japanese Application No. 2014-158782, filed on Aug. 4, 2014, the disclosures of which Applications are incorporated by reference herein.

### TECHNICAL FIELD

The present invention relates to an information provision device and information provision system for providing information about users, and an information provision method used in the information provision device.

### BACKGROUND ART

Technology of selecting and delivering advertisements based on the balance information of the owner of each terminal has been conventionally proposed (for example, see Patent Literature (PTL) 1). PTL 1 describes a structure in which advertisement information about appliance information of appliances connected to a home server is delivered to the home server in order to provide advertisements of high preference to the user.

### CITATION LIST

### Patent Literature

PTL 1: Japanese Unexamined Patent Application Publication No. 2002-298014

### SUMMARY OF THE INVENTION

### Technical Problem

With the technique described in PTL 1, only the advertisement information about the appliances connected to the home server is delivered, and so the types of products for which advertisement information is provided are limited. Besides, no consideration is given to the money for the purchase of a product for which advertisement information is delivered.

The present invention has an object of providing an information provision device and information provision system that enable a user to easily finance the purchase of an advertised product and enable an advertiser to increase the types of products advertised, and an information provision method used in the information provision device.

### Solutions to Problem

An information provision device according to the present invention includes: an obtainer that obtains profit information about a profit gained by a user by performing a measure of reducing a quantity of resource purchased from a provider, based on a result of measuring the quantity of resource by a measurement device; a collector that collects product information including information about a price of a product and advertisement information of the product; an extractor that extracts advertisement information of a product whose product information satisfies a predetermined relationship with the profit information from among the product information collected by the collector, as specific information; and a presentation controller that causes a presentation device to present the specific information extracted by the extractor.

Another information provision device according to the present invention includes: an obtainer that obtains unit profit information about a unit profit which is either a profit gained by a user by performing a measure of reducing a quantity of resource purchased from a provider in a unit period or a profit gained by the user by performing the measure a unit number of times, based on a result of measuring the quantity of resource by a measurement device; a collector that collects product information including information about a price of a product and advertisement information of the product; an extractor that extracts advertisement information to be presented to the user from among the advertisement information collected by the collector, as specific information; a calculator that calculates a target value based on the unit profit information obtained by the obtainer; and a presentation controller that causes a presentation device to present the specific information extracted by the extractor and the target value, wherein the target value is a period or a number of times required for a cumulative sum of the unit profit to reach a price of a product included in the specific information.

An information provision method according to the present invention includes: obtaining, by an obtainer, profit information about a profit gained by a user by performing a measure of reducing a quantity of resource purchased from a provider, based on a result of measuring the quantity of resource by a measurement device; collecting, by a collector, product information including information about a price of a product and advertisement information of the product; extracting, by an extractor, advertisement information of a product whose product information satisfies a predetermined relationship with the profit information from among the product information collected by the collector, as specific information; and causing, by a presentation controller, a presentation device to present the specific information extracted by the extractor.

An information provision system according to the present invention includes: an obtainer that obtains profit information about a profit gained by a user by performing a measure of reducing a quantity of resource purchased from a provider, based on a result of measuring the quantity of resource by a measurement device; a collector that collects product information including information about a price of a product and advertisement information of the product; an extractor that extracts advertisement information of a product whose product information satisfies a predetermined relationship with the profit information from among the product information collected by the collector, as specific information; and a presentation controller that causes a presentation device to present the specific information extracted by the extractor.

### Advantageous Effects of Invention

The present invention enables a user to easily finance the purchase of an advertised product and enables an advertiser to increase the types of products advertised.

### BRIEF DESCRIPTION OF DRAWINGS

FIG. 1 is a block diagram illustrating a system including an information provision device in Embodiment 1.

FIG. 2 is a block diagram illustrating a variation of the system including the information provision device in Embodiment 1.

FIG. 3 is a diagram illustrating an example of operation by the information provision device in Embodiment 1.

FIG. 4 is a diagram illustrating an example of display by a presentation device in Embodiment 1.

FIG. 5 is a diagram illustrating an example of display by the presentation device in Embodiment 1.

FIG. 6A is a block diagram illustrating another example of structure in Embodiment 1.

FIG. 6B is a flowchart illustrating an information provision method in Embodiment 1.

FIG. 7 is a block diagram illustrating an information provision device in Embodiment 2.

FIG. 8 is a diagram illustrating an example of display by a presentation device in Embodiment 2.

FIG. 9 is a diagram illustrating an example of display by a presentation device in Embodiment 3.

FIG. 10 is a diagram illustrating an example of display by the presentation device in Embodiment 3.

FIG. 11 is a diagram illustrating an example of display by a presentation device in Embodiment 4.

### DESCRIPTION OF EXEMPLARY EMBODIMENTS

In recent years, there have been proposals to manage the quantity of resource purchased from a provider and the quantity of resource consumed, for energy saving. The installation of a measurement device for measuring the quantity of resource purchased and the quantity of resource consumed and a home energy management system (HEMS) controller for receiving measurement results from the measurement device on the resource consumer side has thus been proposed. The controller monitors changes in the quantity of resource purchased and the quantity of resource consumed based on the quantity of resource measured by the measurement device.

The changes in the quantity of resource monitored by the controller are presented by a special-purpose presentation device or a general-purpose presentation device such as a smartphone or a tablet terminal. Visualizing the changes in the quantity of resource in this way enables the resource user to be aware of resource saving.

An information provision device described below can provide information about the user using information about the user's profit on the assumption that a reduction in the quantity of resource purchased by the user is the user's profit, in conjunction with the controller.

Although the following embodiments describe the case where the resource is power (electric power), the techniques described below are applicable to any other resource, such as gas or water, which is routinely supplied from the provider to the user and for which the user pays the price corresponding to the quantity used to the provider.

The embodiments described below are based on the premise that, in the case where the user performs a measure to reduce the quantity of resource purchased from the provider, the user gains a profit by the measure. The measure may be performed by the user's actual action, or performed automatically by a device possessed by the user.

The profit may be, for example, the amount of money calculated using the difference between the quantity of resource purchased by the user from the provider in a predetermined period and a preset reference quantity to be compared with the quantity of resource purchased in the predetermined period. The predetermined period is, for example, a period on the basis of which the user pays for the quantity of resource purchased from the provider, and is typically one month or two months.

The reference quantity may be set by the user together with a target value (described later). The HEMS controller includes a storage (not illustrated) for storing the reference quantity and target value set using an operation device so that the user can set any reference quantity and target value. The operation device is a terminal device capable of communicating with the controller. The terminal device is selected from a smartphone, a tablet terminal, a personal computer, etc.

For example, the reference quantity may be set based on the quantity of resource purchased by the user from the provider in the past. In this case, the reference quantity is determined based on the quantity of resource purchased in the previous month, the quantity of resource purchased in the same month of the previous year, the average quantity of resource purchased in the same month of the past several years, or the like. In the embodiments described below, the quantity of resource purchased in the same month of the previous year is used as the reference quantity. The reference quantity set based on the past results in this way is objective, and also the user is saved from having to set the reference quantity.

In the case where the reference quantity is the quantity of resource purchased in the previous month, the same quantity of resource is used in a predetermined period. For example, if the reference quantity for the quantity of resource purchased in June is the quantity of resource purchased in May, then the reference quantity for the quantity of resource purchased in July and August is also the quantity of resource purchased in May. In the case of setting a target amount of money as described later, the predetermined period mentioned here may be a period until the target amount of money is reached, with an upper limit of the period having been set.

Profit information is information representing the profit by the amount of money, and the reference quantity is set by the user or set as a specified value. For example, in the case where the reference quantity is the quantity of resource purchased in the same month of the previous year as mentioned above, the profit is the difference between the amount of money paid by the user to the provider for the quantity of resource and the amount of money corresponding to the reference quantity. This assumes the case where the amount of payment is determined depending on the quantity of resource.

In the case where the quantity of resource purchased is less than the reference quantity, the user gains the profit as a result of the resource saving measure. In the case where the quantity of resource purchased is more than the reference quantity, the user does not perform the resource saving measure. Here, if the quantity of resource purchased is reduced to the reference quantity, the amount of money corresponding to the difference between the amount of payment for the current quantity of resource and the amount of payment in the case of reducing the quantity of resource to the reference quantity is the profit.

The profit may be a reward given to the user when, in the case where the provider provides demand response (DR) information of a power saving request to the user, the user saves power according to the DR information. The amount of reward gained in this way is used as the profit information. In the case where the user possesses a facility for supplying power such as a solar power generation facility or an electrical storage device, the profit may be the quantity of power supplied from the user side to a power system. In this case, the profit for the predetermined period is converted to the amount of money, and the amount of money is used as the profit information.

The profit gained with respect to the reference quantity and the profit gained from the facility for supplying power are routinely obtained, and so the profit information is typically determined with regard to a cumulative value of profits in a unit period. Meanwhile, the profit gained by responding to the DR information is sporadically obtained, and so the profit information is typically determined with regard to a unit number of profits.

A structure in which the HEMS controller is installed in a building such as a house and obtains information about power which the user receives from the provider (e.g. an electric power company) is assumed here. Since this type of controller can be treated as a computer including a processor that operates according to a program, a program for achieving the functions of the information provision device can be executed by the controller. The information provision device may be any device other than the HEMS controller, which includes a processor operating according to a program and can be treated as a computer, such as a smartphone, a tablet terminal, or a personal computer. In this case, the presentation device and the information provision device can be realized by one device.

The embodiments described below assume a structure in which the HEMS controller obtains information about power purchased from the provider and communicates with the smartphone or tablet terminal. The information provision device is realized by the smartphone or tablet terminal executing an application program (application). An operation display device included in the smartphone or tablet terminal as a user interface also functions as the presentation device.

The embodiments mainly describe the case where the presentation device presents advertisement information of products. The products may include not only goods but also services. Advertisement information of a product is information that, when presented to a person, encourages the person to purchase the product, and includes information such as the photograph, description, and price of the product. Each product is provided with not only advertisement information but also product information, as described later. The product information is not information to be presented to a person, and includes not only the price of the product but also the type of the product, the seasonality of the product, and attributes concerning the targeted customers if necessary. The customers are stratified by age, sex, residential area, etc.

The advertisement information and the product information are obtained from a web server or a cloud computing system via a telecommunication line such as the Internet. The advertisement information and product information registered in the web server or cloud computing system are managed by the manufacturer or seller of the product or a service provider that presents the advertisement information. The web server is typically realized by a plurality of computers, although it may be realized by one computer. Hereafter, the web server or cloud computing system in which the advertisement information and product information of the product are registered is referred to as “server” without distinguishing them.

The following describes an information provision device according to each of the embodiments with reference to drawings. Each of the embodiments described below shows a specific example of the present invention. The numerical values, shapes, materials, structural elements, the arrangement and connection of the structural elements, steps, the processing order of the steps, etc. shown in the following embodiments are mere examples, and do not limit the scope of the present invention. Of the structural elements in the embodiments described below, the structural elements not recited in any one of the independent claims representing the broadest concepts of the present invention are described as optional structural elements. Note that each drawing is a schematic and does not necessarily provide precise depiction.

### Embodiment 1

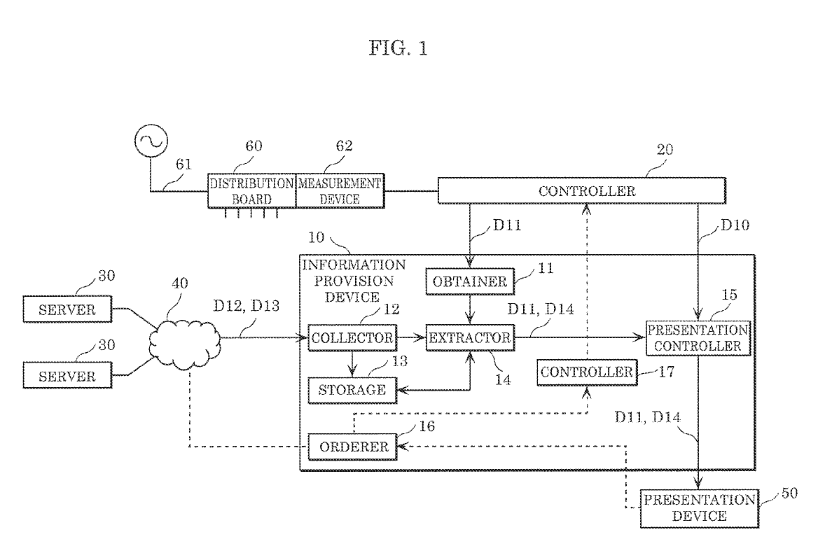

FIG. 1 is a block diagram illustrating a system including information provision device 10 in this embodiment. In the example of the structure illustrated in FIG. 1, information provision device 10 is a device separate from HEMS controller 20.

Controller 20 obtains information about the quantity of resource purchased from a provider, i.e. information about the quantity of power received from power system 61, from measurement device 62 provided to distribution board 60. Measurement device 62 is included in distribution board 60 or placed near distribution board 60. Measurement device 62 has a function of measuring power consumption for each branch circuit separated in distribution board 60.

In the case where the user possesses a device for supplying power to power system 61, controller 20 obtains information about the quantity of power supplied to power system 61. Controller 20 may be capable of communicating with a device for issuing DR information (not illustrated), via a telecommunication line such as the Internet (not illustrated). In this case, controller 20 can control each appliance that consumes the resource to reduce power consumption in the target period corresponding to the DR information.

Controller 20 in this embodiment has a function of calculating the user's profit, using information selected from information about the quantity of power received from power system 61, DR information, information about the quantity of power supplied to power system 61, and the like. With regard to the quantity of power received from power system 61 or the quantity of power supplied to power system 61, the profit is calculated on the basis of a predetermined period. The predetermined period is typically one month. In the case where power saving is performed in response to DR information, on the other hand, the profit is calculated on the basis of a predetermined number of times. The predetermined number of times is typically one.

Information provision device 10 includes obtainer 11 that obtains profit information D11 about the profit calculated by controller 20. Profit information D11 obtained by obtainer 11 from controller 20 is information on the amount of money gained by the user as a result of a measure of reducing the quantity of resource purchased from the provider, and is updated at the timing of gaining profit. The term “reduce” used here is interchangeable with the term “save”.

This embodiment assumes a structure in which, when controller 20 generates profit information D11, profit information D11 is notified to obtainer 11 in push mode. Alternatively, a structure in which, when information provision device 10 is notified of the generation of profit information D11 from controller 20, information provision device 10 obtains profit information D11 from controller 20 may be used.

Obtainer 11 may have a function of generating profit information D11 by converting the profit into the amount of money, instead of receiving the information of the amount of money corresponding to the profit from controller 20. In this case, obtainer 11 receives information such as differences in the quantity of power between unit prices, rewards for responding to DR information, and the quantity of power sold, from controller 20.

Information provision device 10 communicates with server 30 in which advertisement information and product information are registered, via telecommunication line 40 such as the Internet. Collector 12 collects product information D12 and advertisement information D13 from server 30 via telecommunication line 40. Product information D12 and advertisement information D13 collected by collector 12 are not limited to information provided by one manufacturer or seller, but may be information provided by a plurality of manufacturers or a plurality of sellers. Collector 12 may collect product information D12 and advertisement information D13 from server 30 not in pull mode but in push mode.

The timing at which collector 12 collects product information D12 and advertisement information D13 from server 30 is at least one of a timing determined by collector 12 and a timing determined based on profit information D11. The timing in the case of collecting product information D12 and advertisement information D13 from server 30 in push mode is determined by server 30.

The timing determined by collector 12 is, for example, the first day of each month, every Sunday, the first Monday of each month, or the like, based on the date and time indicated by a built-in clock. These timings are merely examples, and the rule by which collector 12 determines the timing is set as appropriate. The case where the timing of collecting product information D12 and advertisement information D13 by collector 12 is determined based on profit information D11 will be described later.

Storage 13 stores product information D12 and advertisement information D13 collected by collector 12. Storage 13 may also store user information about the user. The user information is information that can be used to determine which products are likely to interest the user, from among user-related information such as the age, sex, residential area, occupation, preference, and constitutional predisposition (e.g. sensitivity to heat, sensitivity to cold) of the user.

Such user information is used to extract advertisement information D13 to be presented to a target of product provision. In other words, when the attributes included in the product target (targeted customer) and the attributes included in the user information satisfy a predetermined condition, advertisement information D13 of the corresponding product becomes a candidate for information to be presented to the user.

Information provision device 10 includes extractor 14 that extracts specific information D14 from advertisement information D13 stored in storage 13. Extractor 14 extracts advertisement information D13 of a product whose product information D12 satisfies a predetermined relationship with profit information D11, as specific information D14. In detail, when extractor 14 receives profit information D11 from controller 20, extractor 14 designates a condition of satisfying the predetermined relationship with profit information D11 for product information D12 stored in storage 13, and searches for a product. Extractor 14 further extracts advertisement information D13 corresponding to the product extracted from storage 13, as specific information D14. Specific information D14 extracted by extractor 14 is presented by presentation device 50 via presentation controller 15, together with profit information D11.

The predetermined relationship is any of various relationships including; the price of the product in product information D12 being within the range of the amount of money in profit information D11; the price of the product in product information D12 being slightly more than the amount of money in profit information D11; and the price of the product in product information D12 being about an integral multiple of the amount of money in profit information D11. The amount of money slightly more than the amount of money in profit information D11 is, for example, about 20% higher than the amount of money in profit information D11, or a predetermined amount such as about 1,000 yen higher than the amount of money in profit information D11. Regarding the amount of money within the range of the amount of money in profit information D11, too, a lower limit may be set with an appropriate proportion or amount of reduction.

For example, in the case where the amount of money in profit information D11 is 4,000 yen, 20% higher than the amount of money is 4,800 yen, and 1,000 yen higher than the amount of money is 5,000 yen. In the case of setting the lower limit, 20% lower than the amount of money is 3,200 yen, and 1,000 yen lower than the amount of money is 3,000 yen. The integral multiple of the amount of money in profit information D11 is, for example, in the range of about 1 to 12 times, as described later. Which relationship is used to extract advertisement information D13 of the corresponding product as specific information D14 by extractor 14 is set beforehand.

Profit information D11 is information about the amount of money which the user gains as a result of reducing the quantity of power purchased from the provider. Extractor 14 extracts a product purchasable with the amount of money in profit information D11 obtained by obtainer 11 from controller 20, based on product information D12. In the case where the type of product to be extracted has been determined, extractor 14 selects a product based only on profit information D11 within the range of the type of product. In the case where the type of product to be extracted has not been determined, extractor 14 checks the user information stored in storage 13 against the target included in product information D12, and selects a product purchasable with the amount of money in profit information D11 within the range where the user information meets the condition of the target.

Extractor 14 selects such a product whose product information D12 satisfies the aforementioned predetermined relationship with profit information D11, and extracts advertisement information D13 of the selected product from storage 13 as specific information D14. Specific information D14 is provided to presentation device 50 selected from a smartphone, a tablet terminal, a personal computer, etc., via presentation controller 15. Profit information D11 and specific information D14 are presented by presentation device 50.

The timing of presenting profit information D11 and specific information D14 by presentation device 50 is designated by timing information D10 from controller 20, in the illustrated example. In this embodiment, timing information D10 is sent from controller 20 to information provision device 10 according to the timing at which the user gains a profit. For example, timing information D10 is sent to information provision device 10 when presenting monthly profit information to the user.

Here, specific information D14 may be updated when timing information D10 is provided from controller 20. In this case, controller 20 determines whether or not to update specific information D14 when timing information D10 is provided next. In other words, controller 20 determines whether or not to update specific information D14 when profit information D11 changes. In the case where advertisement information D13 presented as specific information D14 is unchanged when timing information D10 is provided, extractor 14 maintains specific information D14 before the generation of timing information D10.

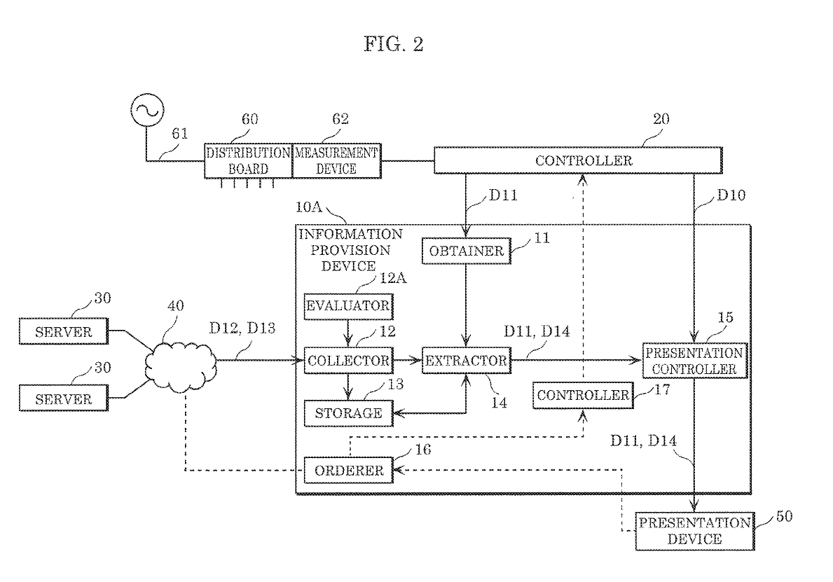

Information provision device 10 may have a function of extracting a type of appliance as a replacement candidate. FIG. 2 is a block diagram illustrating a variation of the system including information provision device 10 in this embodiment.

As illustrated in FIG. 2, information provision device 10A includes evaluator 12A in addition to information provision device 10 in FIG. 1. Evaluator 12A extracts a type of appliance as a replacement candidate from among the appliances used by the user, and provides the extracted type of appliance to collector 12. When collector 12 obtains the type of appliance from evaluator 12A, collector 12 collects advertisement information of each product related to the type of appliance extracted by evaluator 12A.

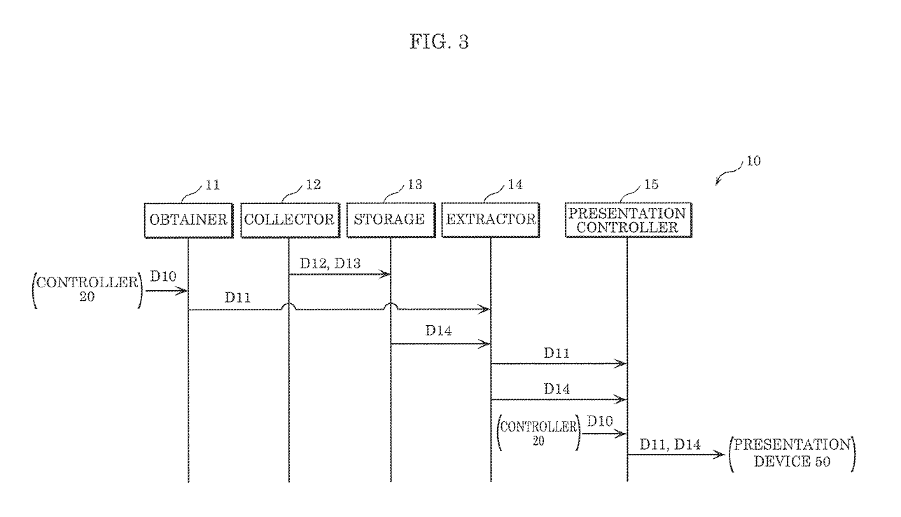

The following describes an example of operation by information provision device 10. FIG. 3 is a diagram illustrating an example of operation by information provision device 10 in this embodiment.

In FIG. 3, collector 12 stores product information D12 and advertisement information D13 in storage 13 beforehand. When obtainer 11 receives profit information D11 from controller 20, extractor 14 extracts advertisement information D13 satisfying the condition from storage 13 as specific information D14. Profit information D11 and specific information D14 are temporarily held in presentation controller 15. After this, when timing information D10 is provided to presentation controller 15, profit information D11 and specific information D14 held in presentation controller 15 are output to presentation device 50.

As described above, the product appropriate to profit information D11 is extracted from product information D12, and specific information D14 as advertisement information D13 of the product is presented by presentation device 50 at the timing based on timing information D10 provided from controller 20. This enables timely advertisement of a product whose price is appropriate to profit information D11. In particular, at such a timing when the user has a sense of accomplishment in having reduced the quantity of power purchased from the provider, a product appropriate to the reduction is advertised to the user. This encourages the user to purchase the product.

If the product purchasable with the amount of money in profit information D11 is unchanged, specific information D14 is unchanged, that is, there is no need to change specific information D14. In the case where there are a plurality of sets of specific information D14, a list of specific information D14 may be presented by presentation device 50. Alternatively, in the case where there are a plurality of sets of specific information D14, specific information D14 of one product may be presented by presentation device 50 once, and changed each time timing information D10 is generated.

Advertisement information D13 of a product typically has an expiration time. Accordingly, in the case where a product has an expiration time set in product information D12 and the expiration time has reached before next timing information D10, the product may be excluded from specific information D14 before next timing information D10.

An example of specific information D14 presented by presentation device 50 is described below. Suppose the amount of money calculated according to the difference between the reference quantity set based on the quantity of power purchased in the previous month and the quantity of power purchased this month is 4,000 yen, that is, the amount of money in profit information D11 is 4,000 yen. Presentation device 50 also serves as a display device of HEMS controller 20. For example, a bar graph representing the quantity of resource purchased in the previous month and the quantity of resource purchased this month is presented on the screen of presentation device 50, with profit information D11 of 4,000 yen (see FIG. 4).

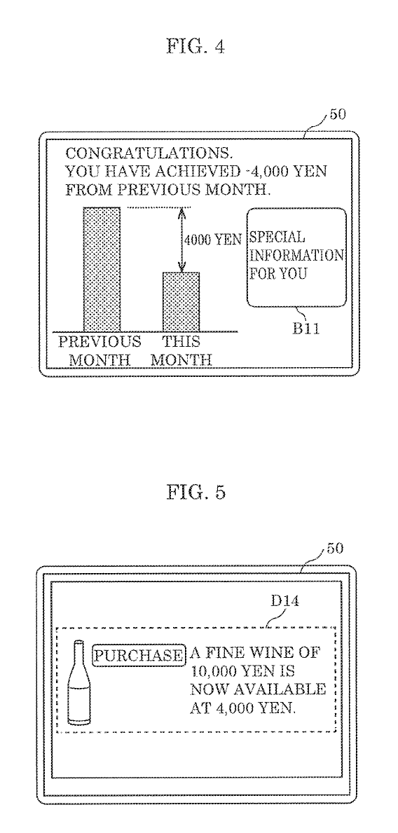

Button B11 is shown on this screen. When the user presses (actually, taps) button B11, specific information D14 is presented on the screen of presentation device 50 as illustrated in FIG. 5. Suppose extractor 14 has selected wine as a product that is likely to interest the user based on the user information. In this case, a wine close in the amount of money (e.g. wine of 4,000 yen) is extracted using product information from among wines purchasable with 4,000 yen, and advertisement information D13 of the extracted wine is extracted as specific information D14.

Of the user information, the user's preference typically needs to be declared by the user. In this embodiment, the user's preference can be obtained automatically or semi-automatically through estimation. It is assumed here that the user's preference is reflected in the goods possessed or used by the user.

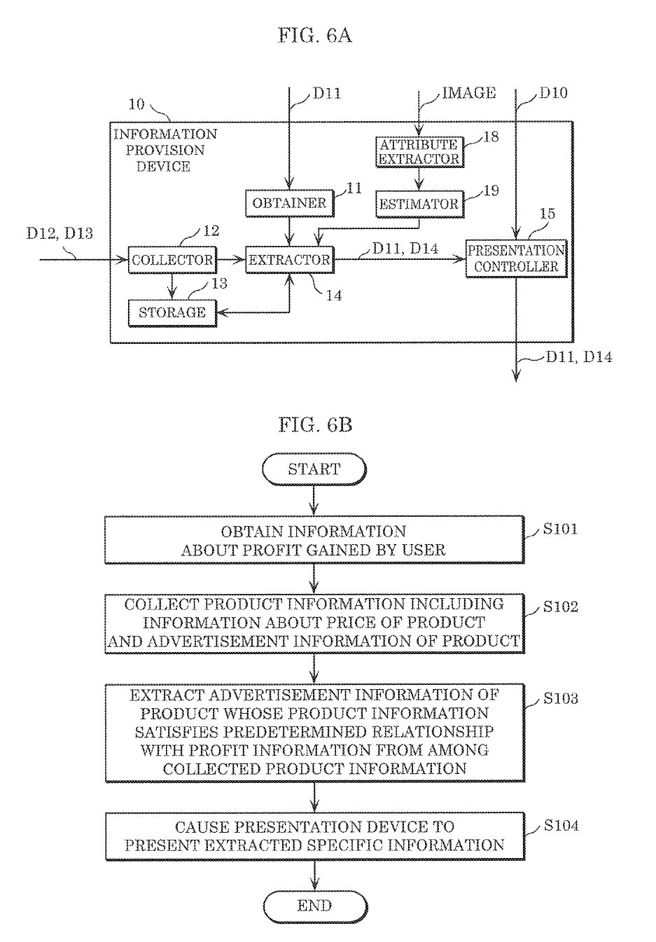

Information provision device 10 may accordingly include: attribute extractor 18 that specifies the goods possessed or used by the user from, for example, an image of the inside of the house captured by the user and extracts the attribute information of the specified goods; and estimator 19 that estimates the user's preference from the attribute information, as illustrated in FIG. 6A. The image may be captured using a smartphone, a tablet terminal, or the like. The attribute information of a good includes the type, product category, manufacturer, color, etc. of the good. Particularly when the good has intended use, the user's preference can be estimated from the type or product category of the good. As an example, when the good is a traveling suitcase, it can be estimated that the user likes traveling. As another example, when the good is a coffee mill or a siphon coffee maker, it can be estimated that the user likes coffee.

Thus, the user's preference may be estimated as user information by analyzing the goods shown in the image captured by the user. The image used to extract goods may be an image of a plurality of goods captured by the user, or an image of a particular good captured by the user to show his or her preference.

As described above, to analyze the goods included in the image and estimate the user's preference, information provision device 10 may include: attribute extractor 18 that extracts the attribute information of the goods in the image; and estimator 19 that estimates the user's preference as user information using the attribute information.

Attribute extractor 18 extracts information such as the outline and feature point of each good from the image, searches a product database that can be searched from image information, and extracts a candidate for the good. The attribute information can be obtained from the product information registered in the product database in association with the extracted good. A cloud service provided by a server device on the Internet may be used for the product database. The candidate for the good may be extracted through matching with a large number of images on the Internet. In this case, the attribute information is extracted from text information accompanying the image of the good, for the candidate for the good extracted from the image. Here, the good does not need to be identified, as long as the type of good can be estimated. Hence, for example in the case where a plurality of candidates for the good are extracted, attribute extractor 18 estimates the type of good using the frequency of each noun included in text and the like.

Estimator 19 extracts information related to a person' preference from the attribute information of the good estimated by attribute extractor 18, and estimates the extracted preference to be the user's preference. For example, estimator 19 includes a wordbook associating attribute information of goods extracted by attribute extractor 18 and words representing persons' preferences with each other, and checks the attribute information extracted by attribute extractor 18 against the wordbook to extract a word representing the preference corresponding to the type of good. The aforementioned processes by attribute extractor 18 and estimator 19 are merely examples.

Although information provision device 10 includes attribute extractor 18 and estimator 19 in the aforementioned structural example, the user's preference may be estimated from the image information using a cloud service provided by a server device on the Internet. In other words, the functions as attribute extractor 18 and estimator 19 may be included in a cloud computing system.

In the structural example in FIG. 1, information provision device 10 includes orderer 16 that, in the case where the user attempts to purchase the product of specific information D14 presented by presentation device 50, performs a procedure of purchasing the product. Orderer 16 has a function of displaying fields for inputting items (name, address, payment method, etc.) for the product purchase procedure on the screen of presentation device 50 and transmitting information input in each field to server 30. Server 30 that receives the purchase procedure does not necessarily need to be the same as server 30 from which product information D12 and advertisement information D13 are obtained. The operation of inputting information in each field may be performed using an operation display device that also serves as presentation device 50.

In the case where the product purchase procedure is performed using orderer 16, the user can be regarded as someone who approves of reducing the quantity of resource purchased from the provider. In detail, given that the user has gained money for purchasing the product by reducing the quantity of resource purchased from the provider, the fact that the user has performed the procedure of purchasing the product indicated by specific information D14 is regarded as showing the user's intention to accept the resource saving measure.

In view of this, when a request is made to reduce the quantity of resource purchased as in the case of DR information, the request may be automatically approved for the user who has performed the product purchase procedure by orderer 16 with the profit gained as a result of the power saving measure. In detail, information provision device 10 in this embodiment includes controller 17. Controller 17 is configured to automatically approve the request to perform the measure of reducing the quantity of resource purchased, in the case where orderer 16 performs the product purchase procedure for the product of specific information D14 presented by presentation device 50.

Presentation controller 15 presents profit information D11 by presentation device 50, and simultaneously presents specific information D14 extracted by extractor 14 by presentation device 50. In the case where presentation device 50 is configured to present images, presentation device 50 generates an image including profit information D11 and specific information D14, and displays the generated image on the same screen. In detail, presentation device 50 presents the degree of power saving in the amount of money and also presents the advertisement of the product purchasable with the amount of money, to the user. Other than visual presentation by images, presentation device 50 may perform auditory presentation by sounds to enable visually impaired people to use the device.

An information provision method executed by information provision device 10 having the aforementioned structure is described below.

FIG. 6B is a flowchart illustrating the information provision method in this embodiment.

In Step S101, obtainer 11 obtains, as profit information, information about a profit gained by the user by performing a measure of reducing the quantity of resource purchased from the provider, based on the result of measuring the quantity of resource by the measurement device.

In Step S102, collector 12 collects product information including information about the price of a product and advertisement information of the product.

In Step S103, extractor 14 extracts advertisement information of a product whose product information collected by collector 12 satisfies a predetermined relationship with the profit information, as specific information.

In Step S104, presentation controller 15 causes presentation device 50 to present the specific information extracted by extractor 14.

Through the series of processes described above, information provision device 10 enables the user to easily finance the purchase of an advertised product and enables the advertiser to increase the types of products advertised. In other words, with information provision device 10, the user can finance the purchase of an advertised product without using other means, and so can save the consumption of resource such as power required if other means is used.

As described above, information provision device 10 in this embodiment includes obtainer 11, collector 12, extractor 14, and presentation controller 15. Obtainer 11 obtains profit information D11 about a profit gained by a user by performing a measure of reducing a quantity of resource purchased from a provider, based on a result of measuring the quantity of resource by measurement device 62. Collector 12 collects product information D12 including information about a price of a product and advertisement information D13 of the product. Extractor 14 extracts advertisement information D13 of a product whose product information D12 satisfies a predetermined relationship with profit information D11 from among product information D12 collected by collector 12, as specific information D14. Presentation controller 15 causes presentation device 50 to present specific information D14 extracted by extractor 14.

With this structure, the profit gained by the user as a result of the measure of reducing the quantity of resource purchased from the provider is presented to the user in association with products. Accordingly, the user can easily recognize the effect of reducing the quantity of resource purchased.

In addition, the user's effort in reducing the quantity of resource is represented in the form of products. If the user is attracted to any of the presented products, the user is likely to focus on acquiring the product. In other words, products (including services) appropriate to the user's effort are proposed to the user. Such information provision device 10 can make sensible proposals, without causing the user to feel uneasy by making proposals unaffordable to the user. Moreover, since the result of the measure of reducing the quantity of resource in the user's daily life is presented to the user in an easy-to-understand manner with no need of numerical management, the user can easily realize the effect of reducing the quantity of resource.

Furthermore, having succeeded in purchasing the attractive product, the user is motivated, by the success, to make the effort to save the quantity of resource not only once but many times. Thus, the user is likely to be guided to continuing the effort to save the quantity of resource. This increases the possibility that the user focuses on saving the quantity of resource into the future.

Meanwhile, the manufacture or seller that provides the product can use information provision device 10 as a new channel for promoting the product. In addition, since the product is advertised in association with profit information D11, the user is more encouraged to purchase the product.

In information provision device 10, obtainer 11 may obtain an amount of money calculated using a difference between a reference quantity for the quantity of resource and the quantity of resource purchased by the user in a predetermined period, as profit information D11.

With this structure, even when the user does not possess a device having a function of accepting DR information or a device having a function of supplying power to power system 61, profit information D11 can be calculated by appropriately setting the reference quantity.

In the case where the user determines a target amount of money as a profit goal, the ratio of the amount of money as profit information D11 to the target amount of money represents the achievement degree to the target amount of money. Here, since the amount of money is profit information D11, specific information D14 is the advertisement information of the product corresponding to the amount of money, Hence, information such as “this product is purchasable with about ½ of the target amount of money to be saved this year” can be presented. In other words, even though the user has not achieved the target amount of money, the advertisement of the product appropriate to the amount of money is presented to the user. The seller of the product can increase the product purchase opportunities in this way. Besides, by presenting the goal of purchasing the product apart from the goal of achieving the target amount of money, the user is newly motivated to reduce the quantity of resource purchased.

Moreover, in the case where the quantity of resource purchased by the user in the predetermined period exceeds the reference quantity, obtainer 11 may obtain an amount of money equivalent to a difference from in the case where the quantity of resource is reduced to the reference quantity, as profit information D11.

With this structure, the user who has been unable to save the quantity of resource can be presented with the advertisement of each product appropriate to the amount gained when the quantity of resource is reduced to the reference quantity, by presentation device 50. Thus, by setting the reference quantity, the reduction of the quantity of resource can be associated with the product. The user who is presented with the goal of purchasing the product is motivated to reduce the quantity of resource purchased. Moreover, the seller of the product can increase the product purchase opportunities by presenting the advertisement at appropriate timing.

In the case where the quantity of resource purchased by the user in the predetermined period exceeds the reference quantity, the quantity of resource may not be able to be easily saved with a current appliance. Accordingly, in the case where the quantity of resource exceeds the reference quantity, extractor 14 may preferentially extract advertisement information D13 of a product for saving the quantity of resource purchased, as specific information D14. This type of product may be any appliance selected from air conditioners, refrigerators, lightings, air conditioners, heat pump water heaters, etc., a product for increasing the sensory temperature, a product for decreasing the sensory temperature, or the like.

As mentioned above, in the case where the quantity of resource purchased by the user in a predetermined period exceeds a reference quantity, extractor 14 may preferentially extract advertisement information D13 of a product for reducing the quantity of resource, as specific information D14.

With this structure, the user can purchase the product by paying in advance with money for saving the quantity of resource purchased, and collect the money after purchasing the product. The user is strongly motivated to purchase the product, as he or she is satisfied with spending money for a socially good behavior of saving the quantity of resource and also assured that the money can be collected by saving the quantity of resource after purchasing the product.

In information provision device 10, profit information D11 may be information about a profit gained by the user in a unit period or a profit gained by the user by performing the measure a unit number of times. In this case, extractor 14 extracts advertisement information D13 of the product purchasable with a predicted amount of money calculated by multiplying a unit amount of money corresponding to profit information D11 by a predetermined number, as specific information D14. The unit period is, for example, selected from one month, two months, etc. The unit period is, for example, once.

With this structure, using the amount of money of the profit of the unit period or the unit number of times as the unit amount, the predicted amount can be calculated by multiplying the unit amount by a predetermined number. In the case where the amount of money of the unit period is used as the unit amount, the predicted amount can be calculated with the period being set. In the case where the amount of money of the unit number of times is used as the unit amount, the predicted amount can be calculated with the number of times being set. In other words, the set period or the set number of times is the multiple for calculating the predicted amount from the unit amount. Having learned the predicted amount gained in the set period or the set number of times, the user is motivated to continue the measure of saving the quantity of resource. In particular, even when the profit in a short period is low as compared with the value of the product (purchase price), the user recognizes that he or she can accumulate the profit for acquiring the product. The user is thus motivated to continue the measure of saving the quantity of resource over the unit period or the unit number of times.

For example, information such as “this product is purchasable with the amount of money equivalent to 2-month saving” can be presented. In detail, even when the product is not purchasable with the current profit, the advertisement of the product appropriate to the predicted amount of the future profit is presented to the user. The seller of the product can increase the product purchase opportunities in this way. Moreover, the product appeals the user not only by its price but also in a new perspective such as the period or the number of times.

When the predicted amount of profit is used, advertisement information D13 of a relatively expensive product can also be extracted as specific information D14. For example, the same type of appliance as an appliance in the house is extracted as a candidate for replacing the existing appliance. In this case, the user can be made aware of the period or the number of times until the replacement of the appliance becomes possible. In the case where the product is an appliance, information comparing the performance difference between the existing appliance and the appliance presented by specific information D14 may be presented when presenting specific information D14 to the user. This encourages the user to purchase the product.

In the case where the product is an appliance and it is assumed to be desirable to replace the existing appliance in terms of life or efficiency, this type of appliance may be set as a replacement candidate, and extractor 14 may extract advertisement information D13 of the replacement candidate appliance as specific information D14. The replacement candidate appliance for the existing appliance may be selected from among appliances of the same type.

Presentation controller 15 may cause presentation device 50 to present a period or a number of times of the measure required to reach the predicted amount of money calculated by extractor 14, in addition to specific information D14 extracted by extractor 14.

With this structure, the period or the number of times of the measure with which the purchase of the product corresponding to the predicted amount becomes possible is presented by presentation device 50, so that the user can recognize the period or the number of times of the measure until the goal of purchasing the product is achieved. The user is thus motivated to reduce the quantity of resource purchased from the provider, which increases the possibility of selling the product.

Information provision device 10 may further include orderer 16 that performs a purchase procedure for the product included in specific information D14 presented by presentation device 50.

With this structure, when the user attempts to purchase the product of specific information D14 presented by presentation device 50, the user can promptly order the product via orderer 16. This shortens the time from when the user decides to purchase the product to when the user actually purchases the product, and as a result increases the opportunities of the user purchasing products.

Information provision device 10 may further include controller 17 that, in the case where orderer 16 performs the purchase procedure for the product included in specific information D14 presented by presentation device 50, performs the measure of reducing the quantity of resource purchased, when receiving a request to reduce the quantity of resource purchased.

In detail, the user who has ordered the product with the profit gained by reducing the quantity of resource purchased is assumed to have tendency to prefer energy saving, and so is highly likely to accept DR information or the like requesting a reduction in the quantity of resource purchased. Accordingly, for the user who has performed the product purchase order procedure through orderer 16, the request to reduce the quantity of resource purchased is automatically accepted, and how many more times the request needs to be accepted is presented. This eliminates the need to perform the operation of responding to each request such as DR information, thus improving the convenience of the user. Moreover, the requester can estimate the minimum number of times the request will be accepted.

Obtainer 11 may obtain, as profit information D11, the profit gained by the user in the case where the quantity of resource purchased is reduced in response to a request to reduce the quantity of resource purchased.

In detail, in the case where the user reduces the quantity of resource purchased in response to DR information or the like requesting a reduction in the quantity of resource purchased, the advertisement of the product appropriate to the reward received by the user from the provider is presented. Such reward is extra income, which the user is more willing to spend. Presenting the advertisement of the product that can be purchased by such reward increases the product purchase opportunities for the user.

Information provision device 10 may further include storage 13 that stores user information about the user, and product information D12 may include information about a targeted customer of the product. In this case, extractor 14 may extract the advertisement information of the product whose product information D12 satisfies a predetermined relationship with profit information D11 and the user information from among product information D12 collected by collector 12, as specific information D14.

With this structure, the use of the user information can narrow down the products that match the user's preference, and limit the types of products presented as specific information D14. In other words, by narrowing down the types of products presented by presentation device 50 so as to be suitable for the user, needless presentation of products which the user is not willing to purchase is reduced.

In the case where HEMS controller 20 recognizes the power consumption of each branch circuit, the change of the power consumption with time can be used to analyze the user's behavior. Depending on the user's behavior, the user's preference can be estimated and used as user information.

Information provision device 10 may include: attribute extractor 18 that obtains an image captured by the user and extracts attribute information of each good present in the space from the image; and estimator 19 that estimates the user's preference as user information using the attribute information. The image may be captured using a smartphone, tablet terminal, personal computer, etc. of the user. The smartphone, tablet terminal, or personal computer may also serve as presentation device 50. The image captured by the user may be an image of the space used by the user or an image of a good which the user is interested in. In particular, the latter image can be regarded as an image with which the user declares his or her preference, so that the user's preference is easily estimated using the latter image.

With this structure, the attribute information is extracted for the good used by the user through image analysis, and the user's preference is estimated from the attribute information of the good. For example, in the case where a traveling suitcase is shown in the image, attribute information “travel” is extracted, and the user's preference for travel can be estimated as user information from the attribute information.

Typically, the manufacturer or seller that provides advertisements cannot obtain information of the goods in the space used by the user. By attribute extractor 18 and estimator 19, however, the user's preference can be estimated from the image captured by the user. In addition, extractor 14 extracts advertisement information D13 appropriate to the estimated user's preference as specific information D14. Thus, advertisement information D13 appropriate to the user's preference is extracted as specific information D14 without the manufacturer or seller knowing the goods in the space used by the user. The use of the information extracted from the image as user information increases the possibility of providing the information of the product that matches the user's preference, and as a result enhances the effectiveness of the advertisement, as compared with the case of randomly providing advertisement information D13.

Here, by overlaying the image captured by the user and specific information D14 as one screen in presentation device 50, the image can be provided with additional information. In other words, by adding information that augments the image of the real space, augmented reality (AR) is realized. Presentation device 50 may also serve as the display device of HEMS controller 20. In this case, the power consumption corresponding to the appliance specified as a result of the image analysis may be selected from the power consumption of each branch circuit recognized by HEMS controller 20, with information of such selected power consumption being further overlaid in one screen. Specific information D14 added to the image is placed in the image so as not to obstruct the visibility of the image, the power consumption information, etc.

In this embodiment, the user gains the profit as a result of his or her measure of reducing the quantity of resource purchased from the provider. In other words, the user enjoys a reduction in loss or an increase in profit by reducing the quantity of resource purchased. However, the technique in this embodiment can also be employed for such an event that does not involve a substantial increase of money, such as an improvement in air quality, by evaluating the degree of the event as a profit.

Although the above describes an example where information provision device 10 is separate from controller 20, information provision device 10 may be a part of controller 20. Information provision device 10 may obtain profit information D11 calculated in a server (not illustrated) that obtains the power consumption value from controller 20, instead of obtaining profit information D11 from controller 20. Thus, controller 20 may transmit the power consumption value to the server which calculates profit information D11 based on the power consumption value. In this case, information provision device 10 receives profit information D11 generated by the server.

The above describes an example where product information D12 and advertisement information D13 are collected from server 30 and stored in storage 13 and, when obtaining profit information D11 from controller 20, extractor 14 extracts specific information D14 from storage 13. In this structure, if there is no limit to product information D12 and advertisement information D13 stored in storage 13, the information stored in storage 13 may be enormous. The amount of information can be controlled if the information collected by server 30 is limited by the user information or limited by a set target amount of money.

In view of this, when obtainer 11 receives profit information D11, extractor 14 extracts the product of product information D12 appropriate to profit information D11 from server 30, and extracts advertisement information D13 of the product from server 30 as specific information D14. With this structure, extractor 14 extracts specific information D14 from server 30 based on profit information D11, so that there is no need to store product information D12 and advertisement information D13 in storage 13 beforehand.

### Embodiment 2

In the structure described in Embodiment 1, the advertisement of the product appropriate to profit information D11 is presented by presentation device 50. As a result of presenting the product advertisement to the user, the user reduces the quantity of resource for the goal of purchasing the product. Meanwhile, the manufacturer or seller of the product has more opportunities to advertise to the user. This embodiment mainly focuses on enhancing the user's motivation to reduce the quantity of resource purchased from the provider, based on the premise that the user who is presented with the product advertisement purchases the product.

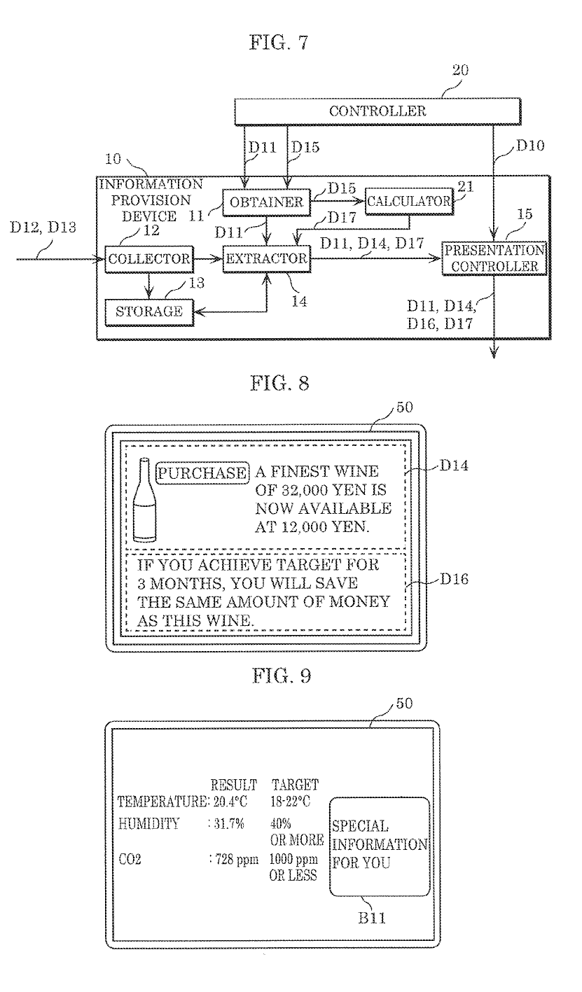

Obtainer 11 in this embodiment has a function of setting a profit gained by the user per unit period or a profit gained by the user per unit number of times as a unit profit, and obtaining information about the unit profit as unit profit information D15 (see FIG. 7). A unit that can be easily referenced to by the user is selected as the unit period or the unit number of times. The unit period is, for example, one month. The unit number of times is, for example, one. The unit period or the unit number of times may be the same as the period or number of times with which timing information D10 is output from controller 20 in Embodiment 1.

Information provision device 10 in this embodiment includes calculator 21, as illustrated in FIG. 7. Calculator 21 calculates, as a target value, the period or number of times required for the cumulative value of the unit profit to reach the amount of money necessary to purchase a predetermined product. A product presented by presentation device 50 as specific information D14 is selected by extractor 14.

Extractor 14 in this embodiment has a function of selecting, from the products whose product information D12 and advertisement information D13 can be collected from server 30, a product that satisfies a predetermined condition. The condition based on which extractor 14 selects the product includes, for example, not only a condition that the purchase price is equivalent to profit information D11 as in Embodiment 1, but also a condition that the purchase price is about several times the amount of the unit profit. About several times the amount of the unit profit means such a multiplying factor that allows the user to maintain the purchase motivation, and may be about 1 to 12. The multiplying factor is not limited to an integer, and may contain a decimal point. The condition when selecting the product may include the user's preference derived from the user information.

Suppose extractor 14 extracts a wine of 12,000 yen which is three times the unit profit of 4,000 yen. With the unit profit of 4,000 yen, the wine of 12,000 yen cannot be purchased. However, when the user repeatedly gains the same profit in three units, the user can purchase the wine. Thus, extractor 14 selects such a product whose purchase price is about several times the amount of the unit profit and that meets the user's preference (i.e. such a product which the user wants). In other words, the purchase price of the selected product is the target amount of money that enables the user to acquire the product.

Calculator 21 calculates the period or number of times required for the measure of gaining the amount of the unit profit in order to purchase the product selected by extractor 14, using unit profit information D15 and product information D12 of the product selected by extractor 14. Calculator 21 sets the period or number of times until the target amount of money is reached, as target value D17. In other words, target value D17 is the period or number of times until the cumulative value of the amount of the unit profit reaches the target amount of money.

For example, in the case where the amount of the unit profit per month is 4,000 yen and the purchase price of the product is 12,000 yen, the measure of gaining the amount of money corresponding to the unit profit needs to be performed for three months. By performing a similar measure for the remaining two months, the user can purchase the desired product. After continuing the same measure for two months, the remaining amount is 4,000 yen, and so the user only needs to perform a similar measure for one more month.

For example, suppose the amount of money corresponding to the unit profit is 4,000 yen. In the case where the unit profit is calculated compared with the previous month as in Embodiment 1, it corresponds to the difference in the quantity of resource purchased from the provider between the previous month and this month. Thus, presentation device 50 presents the quantity of resource purchased in the previous month and the quantity of resource purchased this month, as well as 4,000 yen as the amount of money corresponding to the unit profit, as in the screen illustrated in FIG. 4. The screen illustrated in FIG. 4 includes button B11 to another screen. When the user operates button B11, a screen illustrated in FIG. 8 is displayed by presentation device 50.

The screen illustrated in FIG. 8 includes specific information D14 in the upper part and advice information D16 including the target value in the lower part. Advice information D16 includes the target amount of money which is the purchase price of the product of the advertisement shown as specific information D14, the target value calculated from the relationship with the amount of money corresponding to unit profit information D15, and a message for encouraging to reduce the quantity of resource purchased.

To present advice information D16, for example, presentation controller 15 includes a template such as “if you achieve target for ((purchase price of product)/(unit profit)) months, you will save the same amount of money as this (product)”. Advice information D16 is generated by assigning product information D12 of the product selected by extractor 14 and the amount of money corresponding to unit profit information D15 to this template. In the example in FIG. 8, the product is a wine of 12,000 yen and the amount of money of the unit profit is 4,000 yen, and so advice information D16 “if you achieve target for 3 months, you will save the same amount of money as this wine” is generated.

In this embodiment, by presenting the user with the purchase price of the product selected based on unit profit information D15 as the target amount of money, it is possible to link the target amount of money to the product and make the user realize the target amount of money. Moreover, by presenting the target value to reach the amount of money with which the corresponding product can be purchased to the user, the user is motivated to continue the effort of performing the measure of reducing the quantity of resource purchased.

As described above, information provision device 10 in this embodiment includes obtainer 11, collector 12, extractor 14, calculator 21, and presentation controller 15. Obtainer 11 obtains unit profit information D15 about a unit profit which is either a profit gained by a user by performing a measure of reducing a quantity of resource purchased from a provider in a unit period or a profit gained by the user by performing the measure a unit number of times, based on a result of measuring the quantity of resource by measurement device 62. Collector 12 collects product information D12 including information about a price of a product and advertisement information D13 of the product. Extractor 14 extracts advertisement information D13 to be presented to the user from among advertisement information D13 collected by collector 12, as specific information D14. Calculator 21 calculates a target value based on unit profit information D15 obtained by the obtainer 11. Presentation controller 15 causes presentation device 50 to present specific information D14 extracted by extractor 14 and the target value. The target value is a period or a number of times required for a cumulative sum of the unit profit to reach a price of a product included in specific information D14.

With this structure, the user is presented with a target value a little higher than the result such as the profit (unit profit) in the unit period or the unit number of times, and therefore is motivated to continuously reduce the quantity of resource purchased from the provider.

In a typical house, the profit in the unit period or the unit number of times is assumed to be not more than 10,000 yen when converted into the amount of money. However, when a target value corresponding to a profit several times that of the unit period or the unit number of times is set, the user can be made aware of a relatively expensive product. As a result, the user is willing to reduce the quantity of resource purchased from the provider over a relatively long period. In other words, setting the target value corresponding to the profit several times that of the unit period or the unit number of times motivates the user to continue saving the resource. Moreover, the advertiser that provides advertisement information D13 can advertise a relatively expensive product, i.e. advertise shopping goods. The other structures and operations in this embodiment are the same as those in Embodiment 1.

### Embodiment 3

The foregoing embodiments describe the case where a reduction in the quantity of resource purchased from the provider is regarded as a profit for the user, and converted into the amount of money and presented to the user.

HEMS controller 20 is capable of obtaining information from a sensor if necessary, and managing indoor air quality or the like in conjunction with the sensor.

Suppose indoor air quality is to be managed by controller 20 and controller 20 sets reference air quality. The reference air quality may be a publicly released value. Obtainer 11 in information provision device 10 in this embodiment receives not only profit information D11 but also information (hereafter, management information) such as the power consumption of each branch circuit and the operation of each appliance supplied with power from the branch circuit, from controller 20. The management information includes information on whether or not the reference air quality is achieved. Air quality is determined according to the content of each substance in the air, and the substances in the air include, for example, carbon dioxide, carbon monoxide, dust, and volatile organic compounds. The air quality may include humidity, temperature, and the like.

Extractor 14 in information provision device 10 in this embodiment has a function of, in the case where the reference air quality is not achieved, preferentially extracting advertisement information D13 of a product for improving the air quality as specific information D14. Examples of this type of product include an air purifier, an air conditioner, a humidifier, and a dehumidifier. In the case where it is known from the user information that the user is already using this type of product, extractor 14 extracts an advertisement for replacement with a product having a higher air quality improvement effect as specific information D14, on the ground that the reference air quality cannot be achieved with the existing product. Whether or not the user is already using this type of product may be determined by image analysis of an image captured by the user. For example, which product is possessed or used by the user can be estimated through image analysis on an image captured by the user using a smartphone, a tablet terminal, or the like. If the user is not using this type of product, extractor 14 extracts an advertisement for proposing a product necessary to achieve the reference value as specific information D14.

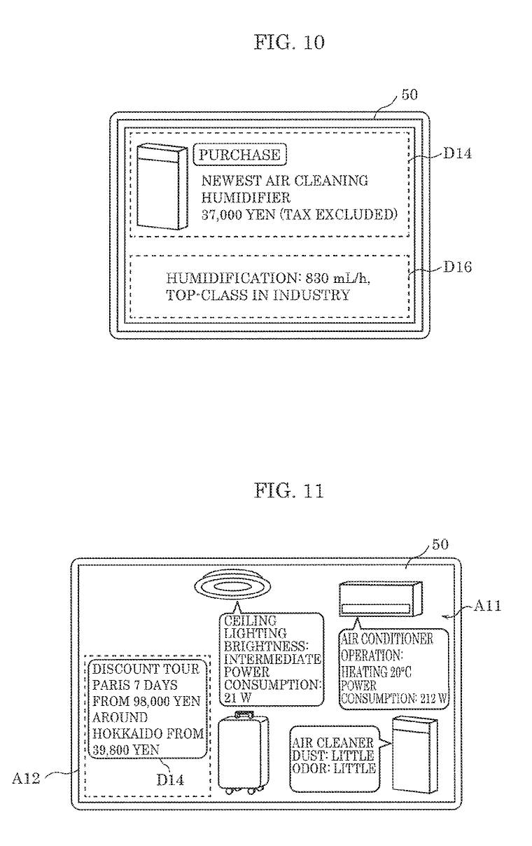

In the example of the screen of presentation device 50 illustrated in FIG. 9, the result and the reference value are shown for temperature, humidity, and carbon dioxide in the air quality. In the illustrated example, temperature and carbon dioxide meet the reference values, but humidity is below the reference value. In such a case, when the user presses button B11, specific information D14 including an advertisement of a humidifier as a product for increasing humidity is presented on the screen of presentation device 50 as illustrated in FIG. 10. In the screen in FIG. 10, too, advice information D16 is presented in the lower part as in Embodiment 2. Advice information D16 here includes information about the performance of the product.

Thus, extractor 14 uses not only the user's preference obtained from the user information but also the air quality information, to provide an advertisement of a product for improving air quality to the user.

In detail, in this embodiment, obtainer 11 has a function of obtaining information on whether or not a reference value is achieved with regard to indoor air quality, and extractor 14 preferentially extracts advertisement information D13 of a product for improving air quality as specific information D14 in the case where the reference air quality is not achieved.

With this structure, regarding air quality that cannot be improved with an existing facility or device, information of a new product can be provided to the user. The user can then not only reduce the quantity of resource but also improve indoor air quality. The other structures and operations in this embodiment are the same as those in Embodiment 1 or 2.

### Embodiment 4

The foregoing embodiments are based on an assumption that, in the case where there are a plurality of types of specific information D14 extracted by extractor 14, specific information D14 about the plurality of products are displayed in list form or are displayed in sequence. Here, the order in which the plurality of products are arranged is not taken into consideration.

This embodiment employs a structure in which, in the case where the user's preference is estimated based on the image captured by the user as described in Embodiment 1, presentation controller 15 presents advertisement with higher priority being given to a product relating to the user's preference. This embodiment also employs a structure in which, in the case of displaying one screen in which the management information of controller 20 and specific information D14 are overlaid on the image captured by the user in the house, presentation controller 15 presents advertisement with higher priority being given to a product relating to a good shown in the image. The product relating to the good mentioned here is a product whose attribute information selected from the good type, product category, manufacturer, color, etc. is the same as or in a predetermined range from that of the good in the image. While the advertiser that provides advertisement information D13 usually cannot directly learn about the user's preference, advertisement that is likely to interest the user can be efficiently provided by estimating the user's preference from the image captured by the user.

As illustrated in FIG. 11, presentation controller 15 preferentially secures area A11 for displaying the management information received from controller 20 on the screen of presentation device 50, and sets area A12 for displaying specific information D14 to be relatively small as compared with area A11. The information recognized by controller 20 for each branch circuit is presented in area A11, and specific information D14 about tours is presented in area A12 as the advertisement information of the products relating to the traveling suitcase shown in the image. By setting the structure of the screen displayed on presentation device 50 as illustrated in FIG. 11, the advertisement can be provided without obstructing the display of the management information. If the user is interested in the advertisement, the user can enlarge the advertisement on the screen by designating (e.g. tapping) area A12. The other structures and operations in this embodiment are the same as those in Embodiment 1, 2, or 3.

### Variations of Each Embodiment

The following describes variations of each of the foregoing embodiments.

Although each of the foregoing embodiments describes the structure (e.g. FIG. 1) in which information provision device 10 or the like includes the functional blocks such as obtainer 11 as an example, the functional blocks in information provision device 10 or the like may be distributed between a plurality of devices connected to be capable of communicating with each other. Moreover, part of the functional blocks in information provision device 10 or the like may be placed in controller 20.

In this case, information provision device 10 or the like in each of the foregoing embodiments is realized as an information provision system including the plurality of devices and controller 20.

An information provision system includes: obtainer 11 that obtains profit information about a profit gained by a user by performing a measure of reducing a quantity of resource purchased from a provider, based on a result of measuring the quantity of resource by a measurement device; collector 12 that collects product information including information about a price of a product and advertisement information of the product; extractor 14 that extracts advertisement information of a product whose product information satisfies a predetermined relationship with the profit information from among the product information collected by collector 12, as specific information; and presentation controller 15 that causes a presentation device to present the specific information extracted by extractor 14.

This produces the same advantageous effects as information provision device 10 or the like in each of the foregoing embodiments.

As described above, information provision device 10 according to the embodiment includes: obtainer 11 that obtains profit information about a profit gained by a user by performing a measure of reducing a quantity of resource purchased from a provider, based on a result of measuring the quantity of resource by a measurement device; collector 12 that collects product information including information about a price of a product and advertisement information of the product; extractor 14 that extracts advertisement information of a product whose product information satisfies a predetermined relationship with the profit information from among the product information collected by collector 12, as specific information; and presentation controller 15 that causes presentation device 50 to present the specific information extracted by extractor 14.

Thus, information provision device 10 extracts the advertisement of the product to be presented to the user as the specific information, based on the profit gained by the user as a result of the measure of reducing the quantity of resource purchased from the provider. Hence, the user can easily finance the purchase of the advertised product, by performing the measure of reducing the quantity of resource purchased. In addition, the user can reduce the quantity of resource without being intensely aware of the quantity of resource, as a non-ordinary act of performing the measure of reducing the quantity of resource purchased is replaced with an ordinary act of purchasing the product. Moreover, since the information about the profit is obtained based on the measurement result of the measurement device installed to monitor the quantity of resource purchased from the provider, the user does not need to input the information about the profit. Meanwhile, the advertiser provides the advertisement information based on the information of the profit gained by the user, and so can increase the types of products advertised.

Obtainer 11 may obtain an amount of money calculated using a difference between a reference quantity for the quantity of resource and the quantity of resource purchased by the user in a predetermined period, as the profit information.

In the case where the quantity of resource purchased by the user in the predetermined period exceeds the reference quantity, obtainer 11 may obtain an amount of money equivalent to a difference from in the case where the quantity of resource is reduced to the reference quantity, as the profit information.

The profit information may be information about a profit gained by the user in a unit period or a profit gained by the user by performing the measure a unit number of times, and extractor 14 may extract the advertisement information of the product purchasable with a predicted amount of money calculated by multiplying a unit amount of money corresponding to the profit information by a predetermined number, as the specific information.

Presentation controller 15 may cause the presentation device to present a period or a number of times of the measure required to reach the predicted amount of money calculated by extractor 14, in addition to the specific information extracted by extractor 14.

Information provision device 10 may further include orderer 16 that performs a purchase procedure for the product included in the specific information presented by presentation device 50.

Information provision device 10 may further include controller 17 that, in the case where orderer 16 performs the purchase procedure for the product included in the specific information presented by presentation device 50, performs the measure of reducing the quantity of resource purchased, when receiving a request to reduce the quantity of resource purchased.

Obtainer 11 may obtain, as the profit information, the profit gained by the user in the case where the quantity of resource purchased is reduced in response to a request to reduce the quantity of resource purchased.

Information provision device 10 may further include an evaluator that extracts a type of an appliance as a replacement candidate from among appliances used by the user, and collector 12 may collect the advertisement information of the product relating to the type of the appliance extracted by the evaluator.

Information provision device 10 may further include storage 13 that stores user information about the user, wherein the product information includes information about a targeted customer of the product, and extractor 14 extracts the advertisement information of the product whose product information satisfies a predetermined relationship with the profit information and the user information from among the product information collected by collector 12, as the specific information.

Information provision device 10 according to the embodiment includes: obtainer 11 that obtains unit profit information about a unit profit which is either a profit gained by a user by performing a measure of reducing a quantity of resource purchased from a provider in a unit period or a profit gained by the user by performing the measure a unit number of times, based on a result of measuring the quantity of resource by measurement device 62; collector 12 that collects product information including information about a price of a product and advertisement information of the product; extractor 14 that extracts advertisement information to be presented to the user from among the advertisement information collected by collector 12, as specific information; calculator 21 that calculates a target value based on the unit profit information obtained by obtainer 11; and presentation controller 15 that causes presentation device 50 to present the specific information extracted by extractor 14 and the target value, wherein the target value is a period or a number of times required for a cumulative sum of the unit profit to reach a price of a product included in the specific information.

Presentation controller 15 may generate, in association with the specific information extracted by extractor 14, advice information including the target value and encouraging the user to purchase the product, and cause presentation device 50 to present the advice information together with the specific information.

In the case where the quantity of resource purchased by the user in a predetermined period exceeds a reference quantity, extractor 14 may preferentially extract advertisement information of a product for reducing the quantity of resource, as the specific information.

An information provision method according to the embodiment includes: obtaining, by obtainer 11, profit information about a profit gained by a user by performing a measure of reducing a quantity of resource purchased from a provider, based on a result of measuring the quantity of resource by a measurement device; collecting, by collector 12, product information including information about a price of a product and advertisement information of the product; extracting, by extractor 14, advertisement information of a product whose product information satisfies a predetermined relationship with the profit information from among the product information collected by collector 12, as specific information; and causing, by presentation controller 15, a presentation device to present the specific information extracted by extractor 14.

A program according to this embodiment is a program for causing a computer to execute the aforementioned information provision method.

An information provision system according to the embodiment includes: obtainer 11 that obtains profit information about a profit gained by a user by performing a measure of reducing a quantity of resource purchased from a provider, based on a result of measuring the quantity of resource by a measurement device; collector 12 that collects product information including information about a price of a product and advertisement information of the product; extractor 14 that extracts advertisement information of a product whose product information satisfies a predetermined relationship with the profit information from among the product information collected by collector 12, as specific information; and presentation controller 15 that causes presentation device 50 to present the specific information extracted by extractor 14.

The embodiments described above are mere examples of the present invention. The present invention is not limited to the embodiments, and various changes can be made to the embodiments depending on design and the like without departing from the technical concept of the present invention.

1. An information provision device comprising:
an obtainer that obtains profit information about a profit gained by a user by performing a measure of reducing a quantity of resource purchased from a provider, based on a result of measuring the quantity of resource by a measurement device;
a collector that collects product information including information about a price of a product and advertisement information of the product;
an extractor that extracts advertisement information of a product whose product information satisfies a predetermined relationship with the profit information from among the product information collected by the collector, as specific information; and
a presentation controller that causes a presentation device to present the specific information extracted by the extractor.

2. The information provision device according to claim 1,
wherein the obtainer obtains an amount of money calculated using a difference between a reference quantity for the quantity of resource and the quantity of resource purchased by the user in a predetermined period, as the profit information.

3. The information provision device according to claim 2,
wherein in the case where the quantity of resource purchased by the user in the predetermined period exceeds the reference quantity, the obtainer obtains an amount of money equivalent to a difference from in the case where the quantity of resource is reduced to the reference quantity, as the profit information.

4. The information provision device according to claim 1,
wherein the profit information is information about a profit gained by the user in a unit period or a profit gained by the user by performing the measure a unit number of times, and
the extractor extracts the advertisement information of the product purchasable with a predicted amount of money calculated by multiplying a unit amount of money corresponding to the profit information by a predetermined number, as the specific information.

5. The information provision device according to claim 4,
wherein the presentation controller causes the presentation device to present a period or a number of times of the measure required to reach the predicted amount of money calculated by the extractor, in addition to the specific information extracted by the extractor.

6. The information provision device according to claim 1, further comprising
an orderer that performs a purchase procedure for the product included in the specific information presented by the presentation device.

7. The information provision device according to claim 6, further comprising
a controller that, in the case where the orderer performs the purchase procedure for the product included in the specific information presented by the presentation device, performs the measure of reducing the quantity of resource purchased, when receiving a request to reduce the quantity of resource purchased.

8. The information provision device according to claim 1,
wherein the obtainer obtains, as the profit information, the profit gained by the user in the case where the quantity of resource purchased is reduced in response to a request to reduce the quantity of resource purchased.

9. The information provision device according to claim 1, further comprising
an evaluator that extracts a type of an appliance as a replacement candidate from among appliances used by the user,
wherein the collector collects the advertisement information of the product relating to the type of the appliance extracted by the evaluator.

10. The information provision device according to claim 1, further comprising
a storage that stores user information about the user,
wherein the product information includes information about a targeted customer of the product, and
the extractor extracts the advertisement information of the product whose product information satisfies a predetermined relationship with the profit information and the user information from among the product information collected by the collector, as the specific information.

11. An information provision device comprising:
an obtainer that obtains unit profit information about a unit profit which is either a profit gained by a user by performing a measure of reducing a quantity of resource purchased from a provider in a unit period or a profit gained by the user by performing the measure a unit number of times, based on a result of measuring the quantity of resource by a measurement device;
a collector that collects product information including information about a price of a product and advertisement information of the product;
an extractor that extracts advertisement information to be presented to the user from among the advertisement information collected by the collector, as specific information;
a calculator that calculates a target value based on the unit profit information obtained by the obtainer; and
a presentation controller that causes a presentation device to present the specific information extracted by the extractor and the target value,
wherein the target value is a period or a number of times required for a cumulative sum of the unit profit to reach a price of a product included in the specific information.

12. The information provision device according to claim 11,
wherein the presentation controller generates, in association with the specific information extracted by the extractor, advice information including the target value and encouraging the user to purchase the product, and causes the presentation device to present the advice information together with the specific information.

13. The information provision device according to claim 1,
wherein, in the case where the quantity of resource purchased by the user in a predetermined period exceeds a reference quantity, the extractor preferentially extracts advertisement information of a product for reducing the quantity of resource, as the specific information.

14. An information provision method comprising:
obtaining, by an obtainer, profit information about a profit gained by a user by performing a measure of reducing a quantity of resource purchased from a provider, based on a result of measuring the quantity of resource by a measurement device;
collecting, by a collector, product information including information about a price of a product and advertisement information of the product;
extracting, by an extractor, advertisement information of a product whose product information satisfies a predetermined relationship with the profit information from among the product information collected by the collector, as specific information; and
causing, by a presentation controller, a presentation device to present the specific information extracted by the extractor.

15. An information provision system comprising:
an obtainer that obtains profit information about a profit gained by a user by performing a measure of reducing a quantity of resource purchased from a provider, based on a result of measuring the quantity of resource by a measurement device;
a collector that collects product information including information about a price of a product and advertisement information of the product;
an extractor that extracts advertisement information of a product whose product information satisfies a predetermined relationship with the profit information from among the product information collected by the collector, as specific information; and
a presentation controller that causes a presentation device to present the specific information extracted by the extractor.
